(19) United States
(12) Patent Application Publication
(10) Pub. No.: US 2024/0026695 A1
(43) Pub. Date: Jan. 25, 2024

(54) Concrete Compaction Device with Measurement of Compaction Progress

(71) Applicant: Wacker Neuson Produktion GmbH & Co. KG, Reichertshofen (DE)

(72) Inventors: Christian Lange, Ingolstadt (DE); Rudolf Berger, Gruenwald (DE); Patrick Diller, Hohenwart (DE); Dirk Sibila, Moorenweis (DE); Christian Glanz, Dachau (DE); Alto Weiskopf, Altomuenster (DE)

(21) Appl. No.: 18/225,378

(22) Filed: Jul. 24, 2023

(30) Foreign Application Priority Data
Jul. 25, 2022 (DE) 10 2022 118 542.7

(51) Int. Cl. E04G 21/08; B28B 1/093; B28B 17/00

(52) U.S. Cl. CPC E04G 21/08; B28B 1/0935; B28B 17/0081

(57) ABSTRACT

A concrete compaction device includes a vibrator housing for immersion in flowable concrete, and an unbalance exciter which is driven by an electric motor and which is arranged in the vibrator housing. A current detection device detects the electric current absorbed by the electric motor. Ann evaluation device determines an operating state of the concrete compaction device based on the electric current that is currently detected. The operating state is selected from the group consisting of: positioning of the vibrator housing in the air, immersion of the vibrator housing in the concrete, performance of a compaction process with the vibrator housing immersed in the concrete, and emersion of the vibrator housing from the concrete. The evaluation device is configured to recognize all of these operating states.

### BACKGROUND OF THE INVENTION

### 1. Field of the Invention

The invention relates to a concrete compaction device comprising a device for measurement of compaction progress. In particular, the invention relates to an internal vibrator device, such as an internal vibrator for concrete compaction.

### 2. Description of the Related Art

It is known that fresh concrete must be compacted after being placed in a formwork in order to achieve a specific density while avoiding gas pores or so-called “gravel pockets”. A 10% lower density of the concrete already results in a halving of the compressive strength. Excessive compaction of the concrete, however, can lead to an unmixing of the concrete with accumulation in zones of cement paste.

Larger concrete pours are usually compacted manually using vibrators or alternatively agitators, such as hose or rod vibrators. Such vibrators are internal vibrators, on the inside of which an unbalance is driven via an electric motor inside a vibrating head (vibrator housing) that is immersed in the fresh concrete, whereby oscillations are caused that compact the concrete. While concrete as a building material is subject to diverse and stringent quality controls, the proper compaction of concrete, however, depends to a large extent on the individual skills of the operator of the internal vibrator. The operator alone determines whether an optimum and uniform compaction result is obtained. However, since the individual skills of different operators can inherently vary greatly, the compaction quality can also vary considerably, which in certain cases leads to an unsatisfactory compaction result and thus to insufficient concrete strength.

GB-A-1097651 discloses an internal vibrator in which the power draw of an electric motor driving an unbalanced mass is taken as an indication of the degree of compaction of the concrete to be compacted. The measurement of the consumption of current and its rough interpretation does not allow a reliable determination of the degree of compaction.

EP 1 165 907 B1 describes an internal vibrator with a measurement system for determining the compaction progress in concrete. The vibrations at the vibrating head are detected, from which conclusions can be drawn about the compaction effect. The use of corresponding acceleration sensors on the vibrating head is however difficult to implement in practice due to the strong oscillations and harsh ambient conditions. Furthermore, additional signal lines are necessary in a mechanically highly stressed environment.

As before, a measurement and documentation of the compaction progress is hardly possible in concrete technology. The duration of compaction and the number of immersion processes with an internal vibrator, as well as the choice of immersion points are mostly based on the experience of the user.

### SUMMARY OF THE INVENTION

The invention is therefore based on the task of specifying a concrete compaction device, in particular an internal vibrator device, in which the degree of compaction of the concrete currently being compacted can be reliably detected.

The task is solved according to the invention by a concrete compaction device includes a vibrator housing for immersion in flowable concrete, and an unbalance exciter which driven by an electric motor and which is arranged in the vibrator housing. A current detection device is configured to detect the electric current absorbed by the electric motor. An evaluation device is configured to determine an operating state of the concrete compaction device based on the electric current that is currently detected. The operating state is selected from the group consisting of: “positioning of the vibrator housing in the air” (“operation of the electric motor at no load”), “immersion of the vibrator housing in the concrete,” “performance of a compaction process with the vibrator housing immersed in the concrete,” and “emersion of the vibrator housing from the concrete.” The evaluation device is configured to recognize all of these operating states.

The electric motor can be arranged together with the unbalance exciter in the vibrator housing. In one variant, only the unbalance exciter is arranged in the vibrator housing, whereas the electric motor is arranged spatially separated from the vibrator housing in its own housing. In this case, the torque of the electric motor is transmitted via a flexible shaft to the unbalance exciter in the vibrator housing.

The operating states can, in particular, be recognized on the basis of the respective precisely detected current flow with a correspondingly high sampling rate. In this, it is not only the current value, but rather also the change in the current values over time (for example, detectable with the help of the sampling rate) that plays a role, so that specific current profiles can be detected and recognized. Based on the tendency of the current flow, the evaluation device can recognize the different operating states and—if useful—also distinguish them one from each other. For this purpose, the respectively detected current profile, with current values and current flows or alternatively gradients can be compared, for example, with known values or alternatively patterns in order to draw conclusions therefrom about the respective operating state.

The operating states “positioning of the vibrator housing in the air” and “operation of the electric motor at no load” are to be regarded as identical. In this case, the vibrator housing is still in the air and is still not immersed in the concrete. The electric motor can be operated at no load or approximately at no load since the unbalance exciter can still rotate freely.

The compaction work begins with the operating state “immersion of the vibrator housing in the concrete”. The vibrator housing is successively immersed into the free-flowing concrete, which absorbs and damps the oscillations of the vibrator housing. During this process, the current draw of the electric motor is increased in order to be able to drive the unbalance exciter as before.

In the operating state “performance of a compaction process,” the vibrator housing is substantially fully immersed in the concrete and is held substantially stationary by the operator at one point such that the vibrator housing dwells in the concrete. Due to the compaction effects in the concrete, the damping effect of the concrete on the vibrator housing changes, which in turn takes the form of opposing forces or alternatively reaction torques acting on the unbalance exciter. This changes the current draw of the electric motor, which can be detected by the evaluation device.

In the operating state “emersion of the vibrator housing from the concrete,” the vibrator housing is emersed from the concrete and lifted. This results in the vibrator housing being able to vibrate in an increasingly free manner, since the damping effect of the concrete gradually decreases. Accordingly, the electric motor can also once again rotate freely, such that the power absorbed by it is reduced and power consumption is lowered.

The evaluation device can be used, with the help of the respectively sampled current values and the gradients of the current values or alternatively the tendency of the current value development, to respectively recognize the working state of the internal vibrator. During the compaction process (“performance of a compaction process”), the evaluation device can recognize the compaction state of the concrete on the basis of the current profile, which is to say the current values and the gradient development, and compare it, for example, with specific limit values. When a certain limit value is reached, this is taken as a criterion that the concrete has been sufficiently compacted at this point.

In one variant, the evaluation device can recognize the operating states “electric motor switched off” and “electric motor and/or unbalance exciter defective” as additional operating states. In this case, the electric motor either does not absorb any current, or a current draw or current profile is recognized that does not fit into the schemes for the normal operating states, for example, a current draw that is too low or too high.

The current detection device can be configured to detect, in addition to the current, also the electric voltage applied to the electric motor. This allows the measurement accuracy to be further increased.

The current detection device may be configured to detect the current with a sampling interval, wherein the sampling interval may be less than 5 s. In particular, the sampling interval may be less than 2 s, less than 1 s, less than 0.5 s, or 1/10 s or less.

The evaluation device can be configured to determine the respective operating state taking into account the respective currently detected current profile with a currently detected electric current and/or a respectively determinable current gradient. The current gradient is a change in the current value present over time. Depending on the absolute current value detected, possibly in conjunction with the current gradient, the evaluation device can thereby detect the operating state and also the degree of compaction in the concrete. In so doing, the current value and current gradient can be evaluated together or separately. An example of the evaluation will be elucidated later in the figure description.

An interpretation device can be provided for interpreting the current flow when the operating state “performance of a compaction process” is recognized, wherein the interpretation device can be configured to evaluate the respective current gradient for interpreting the current flow, and wherein an approach of the current gradient to the zero value is considered a criterion for compaction progress. An approach of the current gradient to the zero value means that the curve of the current flow becomes flatter. This can be observed over the course of the compaction process, wherein an approach of the current gradient to the zero value means that the current, then currently being absorbed, hardly changes at all. This is taken as a criterion that the concrete has been sufficiently compacted in the area of the vibrating head.

A limit value for the approach of the current gradient to the zero value can be specified, wherein a signal device can be provided to generate a signal for an operator upon the reaching of the limit value by the current gradient. Thus, it is not mandatorily required that the current gradient actually reaches the zero value. Rather, a convergence to the zero value and thereby a reaching of the limit value may be sufficient. The reaching of the limit value means that the concrete has been sufficiently compacted at the location. This condition can be determined by the interpretation device, which thereupon signals to the operator, by means of the signal device, that the concrete has been sufficiently compacted so that the operator can move the vibrator housing to another location in the concrete.

A current supply line for supplying the electric current to the electric motor may be provided. In particular, the current detection device may be located in the area of the current supply line to detect the electric current being absorbed by the electric motor.

A power source for the electric motor may be provided, comprising an electric energy storage device and/or a power grid. The electrical energy storage device may be, for example, a rechargeable battery.

In particular, the electrical energy storage device may comprise a portable rechargeable battery, which rechargeable battery is, for example, carried on the back by an operator like a backpack. The electrical current for the concrete compaction device can thus be drawn exclusively from the rechargeable battery carried by the operator. The operator is thus self-sufficient and does not need any external power grid connections.

The current detection device, the evaluation device, and the interpretation device can be arranged on the rechargeable battery or alternatively coupled to the electronics (battery management system) of the rechargeable battery. In particular, these devices can also be (partially) integrated into the battery management system, such as, for example, the current detection device.

The electrical energy storage device can, in particular, comprise control electronics, wherein the current detection device and/or the evaluation device and/or the interpretation device can be coupled to the control electronics. The current detection device, the evaluation device, and/or the interpretation device may also be spatially arranged with the control electronics or alternatively the energy storage device.

### BRIEF DESCRIPTION OF THE DRAWINGS

These and other advantages and features of the invention are explained in more detail below by way of examples with the aid of the accompanying figures. Wherein:

FIG. 1 shows an internal vibrator in schematic representation as a concrete compaction device according to the invention; and

FIG. 2 shows an example of the change in current draw as a function of the different operating states of a concrete compaction device.

### DETAILED DESCRIPTION

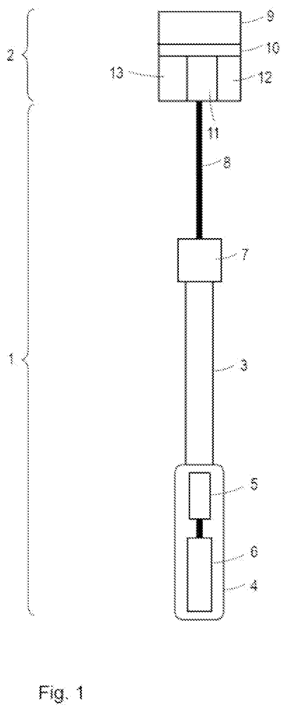

FIG. 1 shows a schematic representation of a concrete compaction system with an internal vibrator 1 and an energy device 2.

The internal vibrator 1 has an operating hose 3, at one end of which a vibrating head 4 serving as a housing is attached. Inside the vibrating head 4, an electric motor 5 is provided which drives an unbalance exciter 6 in rotation. The unbalance exciter 6 can be, for example, an unbalance shaft on which an unbalance mass is mounted eccentrically so that, when the unbalance shaft rotates, oscillations are generated which are introduced into the concrete to be compacted via the outer wall of the housing of the vibrating head 4. The construction of such a vibrating head 4 with electric motor 5 and unbalance exciter 6 is known in itself.

In a variant that is not shown, but which is also known per se, the electric motor 5 is not arranged in the vibrating head 4 but rather in its own housing, spatially separated from the vibrating head 4. In this case, a flexible shaft extends between the electric motor 5 and the unbalance exciter 6 arranged in the vibrating head 4, by means of which flexible shaft the torque of the electric motor 5 can be transmitted to the unbalance exciter 6. The flexible shaft is surrounded by the operating hose 3, which can also be used to guide the vibrating head 4.

The operating hose 3 shown in FIG. 1 can have a length of several meters so that the operator can hang the vibrating head 4 in the concrete to be compacted over a greater distance during compaction work. FIG. 1 is not to scale and does not reflect the actual length of the operating hose 3.

A switching device 7 is attached to the end of the operating hose 3 opposite the vibrating head 4, by means of which switching device the electric motor 5 can be switched on and off. The switching device 7 can also serve as a coupling point for a power line 8 (power cable). The electrical leads of the power line 8 are routed inside the operating hose 3 to the vibrating head 4, so that the operating hose 3 also takes on the function of a protective hose. At the end of the power line 8 opposite the switching device 7, a plug, not shown in FIG. 1, may be provided in a manner known per se.

The connector may be plugged into the energy device 2. In the example shown in FIG. 1, essential parts of the energy device 2 can be arranged on a carrying device which is not shown, which carrying device can be carried by a user, for example, on their back, by means of carrying straps, similar to a backpack. In this case, the carrying device may comprise a carrying frame that reliably supports the components attached to it. This is also described, for example, in DE 10 2018 118 552 A1. The energy device 2 comprises a rechargeable battery 9 as an electrical energy storage device. The rechargeable battery 9 can be switched out when exhausted and replaced with a fresh rechargeable battery 9.

Instead of the rechargeable battery 9, it is also possible to provide an electrical supply via the public power grid or a power network existing at the construction site.

Furthermore, a converter 10 can be part of the energy device 2, which in particular converts the current drawn from the rechargeable battery 9 with regard to voltage and frequency in a manner suitable for the electric motor 5. This converted current is then supplied by the converter 10 to the electric motor 5 via the power line 8.

Symbolically, a current detection device 11, an evaluation device 12 and an interpretation device 13 are also provided on the energy device 2. These components can also be located elsewhere on the internal vibrator. However, their arrangement in the vicinity of the rechargeable battery 9 or alternatively of the converter 10 lends itself well in order to, there, precisely detect and interpret the current drawn by the electric motor 5.

The current detection device 11, the evaluation device 12. and the interpretation device 13 need not be physically separate components. Rather, they may also be arranged in the rechargeable battery 9 or in the battery management system of the rechargeable battery 9, or in the converter 10, or elsewhere. By way of example, the evaluation device 12 and the interpretation device 13 can also be spatially arranged elsewhere, for example, as a software application on a smartphone carried by the operator of the internal vibrator. In this case, a communication link or communication interface must be provided to transmit the current values detected by the current detection device to the evaluation device 12.

The current detection device 11 is used to detect the electric current absorbed by the electric motor 5. It is possible to detect the current in short sampling intervals.

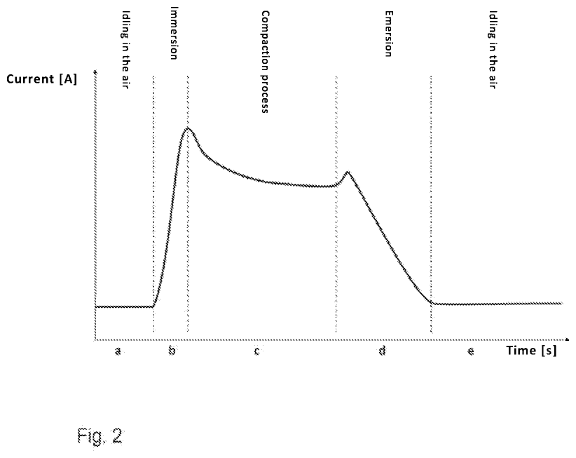

The measurement results of the current detection device 11 are passed on to the evaluation device 12, which can detect an operating state of the internal vibrator based on the then currently detected electric current (current values and current flow or alternatively current gradient), as explained below with reference to FIG. 2.

The interpretation device 13 is intended to interpret the current flow during a compaction process. In particular, the interpretation device 13 is intended to recognize and classify the compaction state during the compaction process.

When the interpretation device 13 determines that the concrete is currently sufficiently compacted, a signal device, not shown, can be used to signal the operator of the internal vibrator 1 to stop compaction at the corresponding location and continue compaction at another location.

Information relating to the state of compaction may be communicated to the operator in various ways. For example, the corresponding data can be displayed to the operator via assistance systems, for example, by applications installed on smartphones. In addition, logging of the measurement results for later documentation is also readily possible.

By way of example, FIG. 2 shows the flow of the current drawn by the electric motor 5 over time during various operating states of the internal vibrator 1. The respective current values can be detected by the current detection device 11 with short sampling intervals.

During phase a, the internal vibrator runs in the air and is not immersed in the concrete (idling phase, operation of the electric motor at no load, positioning of the vibrator housing in the air). In this phase, the absorbed current is constantly low.

During immersion of the vibrator housing in the concrete (phase b), the current draw increases and reaches a detectable maximum.

If the internal vibrator subsequently dwells in the concrete (compaction process), the concrete is compacted in the effective range of the vibrating head 4 (phase c). A partially decreasing current flow can be recognized, with a negative current gradient.

On the basis of the changing current gradients (current drop), the progress of the compaction process can be concluded by the evaluation device 12 in conjunction with the interpretation device 13. The further the compaction process progresses, the flatter the curve progression becomes, which is to say the current gradient approaches zero value. In this, the current absorbed always remains greater than in the idling phase in the air (phase a), so that the states of idling (phase a) and “immersed” or alternatively “compaction” (phase c) can always be clearly distinguished from one another.

When the vibrating head 4 emerses from the concrete (phase d), a brief increase in current can be observed due to the change in position of the vibrating head 4. Subsequently, the current absorbed falls back to the value corresponding to no-load operation as soon as the internal vibrator is in the air again. Finally, the current draw changes again to the no-load phase (phase e).

In particular, in the case of a portable energy device provided in a backpack system with an energy storage device that can be used to operate internal vibrators, measurement devices, for example, in the battery control electronics, are usually already present with which the input power can be measured in the form of current and voltage for operating the internal vibrators. Additional sensor technology, in particular, in the vibrating head or the protective tube, is not required.

Due to the high measurement accuracy and sampling rate, it is possible to infer from the current flow the operating state (no-load, immersion, dwell, emersion) and the compaction progress of the internal vibrator in the concrete. To determine the respective operating state, the measured values or alternatively their curves and changes are compared with known values or, alternatively, patterns.

The measurements can be carried out in a suitable manner for rechargeable battery-powered internal vibrators, but also for mains-powered internal vibrators.

1. A concrete compaction device, comprising:
a vibrator housing that is configured to be immersed in flowable concrete;
an unbalance exciter which is driven by an electric motor and which is arranged in the vibrator housing;
a current detection device that is configured to detect an electric current absorbed by the electric motor; and
an evaluation device that is configured to determine an operating state of the concrete compaction device based on the electric current that is currently detected by the current detection device;
wherein
the operating state is selected from the group consisting of:
positioning of the vibrator housing in the air;
immersion of the vibrator housing in the concrete;
performance of a compaction process with the vibrator housing immersed in the concrete;
emersion of the vibrator housing from the concrete;
and wherein
the evaluation device is configured to recognize all of the operating states of the group of operating states.

2. The concrete compaction device according to claim 1, wherein the evaluation device can recognize the following additional operating states:
the electric motor being switched off;
the electric motor and/or the unbalance exciter being defective.

3. The concrete compaction device according to claim 1, wherein the current detection device is configured to detect, in addition to the current, an electric voltage applied to the electric motor.

4. The concrete compaction device according to claim 1, wherein
the current detection device is configured to detect the current with a sampling interval; and wherein
the sampling interval is less than 5 seconds.

5. The concrete compaction device according to claim 1, wherein the evaluation device is configured to determine the respective operating state taking into account the respective currently detected electric current and/or a respective determinable current gradient.

6. The concrete compaction device according to claim 1, wherein
an interpretation device is provided for interpreting the current flow when an operating state “performance of a compaction process” is recognized;
the interpretation device is configured to evaluate a current gradient for interpreting the current flow; and wherein
an approach of the current gradient to a zero value is considered a criterion for compaction progress.

7. The concrete compaction device according to claim 6, wherein
a limit value for the approach of the current gradient to the zero value is specified; and wherein
a signal device is provided and is configured to generate a signal for an operator upon the reaching of the limit value by the current gradient.

8. The concrete compaction device according to claim 1, further comprising a current supply line that is configured to supply the electric current to the electric motor.

9. The concrete compaction device according to claim 1, wherein a power source for the electric motor comprises an electric energy storage device and/or a power grid.

10. The concrete compaction device according to claim 1, wherein
the electrical energy storage device comprises control electronics; and wherein
the current detection device and/or the evaluation device and/or the interpretation device are coupled to the control electronics.
